(19) United States
(12) Patent Application Publication
(10) Pub. No.: US 2007/0230053 A1
(43) Pub. Date: Oct. 4, 2007

(54) Magnetic recording medium

(75) Inventors: Sok-hyun Kong, Yongin-si (KR); Chee-kheng Lim, Yongin-si (KR); Hoon-sang Oh, Yongin-si (KR); Hoo-san Lee, Yongin-si (KR); Seong-yong Yoon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,217

(22) Filed: Jan. 19, 2007

(30) Foreign Application Priority Data
Mar. 28, 2006 (KR) 10-2006-0028029

(51) Int. Cl. G11B 5/74

(52) U.S. Cl. 360/131

(57) ABSTRACT

A magnetic recording medium is provided. The magnetic recording medium includes: a substrate; a perpendicular magnetic recording layer which is formed over the substrate; a first soft magnetic underlayer which is disposed between the perpendicular magnetic recording layer and the substrate; a second soft magnetic underlayer which is disposed between the first soft magnetic underlayer and the perpendicular magnetic recording layer; and an isolation layer which is disposed between the first soft magnetic underlayer and the second magnetic layer and which prevents magnetic interaction between the first soft magnetic underlayer and the second soft magnetic underlayer, wherein anisotropy field Hₖ of the second soft magnetic underlayer is greater than anisotropy field Hₖ of the first soft magnetic underlayer.

### CROSS-REFERENCE TO RELATED PATENT APPLICATION

This application claims priority from Korean Patent Application No. 10-2006-0028029, filed on Mar. 28, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a magnetic recording medium, and more particularly, to a magnetic recording medium that can reduce magnetic noise generated by magnetic domain walls of a soft magnetic underlayer.

2. Description of the Related Art

It is generally known that perpendicular magnetic recording achieves higher recording density than longitudinal magnetic recording. Accordingly, most hard disk drives (HDDs) today adopt perpendicular recording technology to achieve high recording densities.

In perpendicular magnetic recording, the magnetization of bits of data is aligned in a direction perpendicular to the plane of a corresponding recording medium. Such perpendicular magnetic recording is performed using a double-layered perpendicular magnetic recording medium, which includes a ferromagnetic layer and a soft magnetic underlayer (SUL), and a pole head. The SUL, which is inevitably used due to the magnetic characteristics of the pole head, is disposed under a magnetic recording layer and guides a magnetic flux that adversely results in noise being generated by magnetic domain walls.

Various methods have been proposed to reduce noise generated by magnetic domain walls. Among the methods, there is a related art method of reducing noise generated by magnetic domain walls by forming a recording medium having a multi-layered underlayer structure and establishing an exchange coupling between underlayers. Another related art method is to prevent the formation of magnetic domain walls due to the exchange bias of a ferromagnetic layer by forming the ferromagnetic layer under an underlayer. Another related art method is to prevent the formation of magnetic domains by forming a magnetic domain control layer under an SUL. Since a magnetic domain control layer is formed of an expensive antiferromagnetic material, the method using the magnetic domain control layer is not preferable. Various other methods of reducing noise have been suggested, but so far none have managed to address the problems of noise brought about by increasing recording densities of perpendicular magnetic recording mediums.

### SUMMARY OF THE INVENTION

The present invention provides a perpendicular magnetic recording medium that can effectively reduce noise generated by magnetic domain walls.

According to an aspect of the present invention, there is provided a perpendicular magnetic recording medium including: a substrate; a perpendicular magnetic recording layer which is formed over the substrate; a first soft magnetic underlayer which is disposed between the perpendicular magnetic recording layer and the substrate; a second soft magnetic underlayer which is disposed between the first soft magnetic underlayer and the perpendicular magnetic recording layer; and an isolation layer which is disposed between the first soft magnetic underlayer and the second magnetic layer and which prevents magnetic interaction between the first soft magnetic underlayer and the second soft magnetic underlayer, wherein anisotropy field Hₖ of the second soft magnetic underlayer is greater than anisotropy field Hₖ of the first soft magnetic underlayer.

The second soft magnetic underlayer may form a Ruderman-Kittel-Kasuya-Yosida (RKKY) coupling and include at least one stacked structure in which a pair of unit soft magnetic underlayers is stacked which has a non-magnetic spacer formed therebetween.

The second soft magnetic underlayer may be thinner than the first soft magnetic underlayer. The second soft magnetic underlayer may have a thickness of between 1 and 12 nm, and the first soft magnetic underlayer may have a thickness of 50 nm or more.

The first soft magnetic underlayer and the second magnetic layer may be formed of the same material.

The second soft magnetic underlayer may include two unit soft magnetic underlayers and one spacer formed between the two unit soft magnetic underlayers, wherein each of the unit soft magnetic underlayers has a thickness of between 1 and 5 nm, the spacer has a thickness of 2 nm or less, and the first soft magnetic underlayer has a thickness of 50 nm or more.

The isolation layer may be formed of a non-magnetic metal or a non-metallic material. The perpendicular magnetic recording medium may further include a magnetic domain control layer which is disposed between the first soft magnetic underlayer and the substrate.

The second soft magnetic underlayer may be formed of one selected from CoZrNb, CoZrTa, an FeTa alloy, and an FeCo alloy. The first soft magnetic underlayer may be formed of one selected from a NiFe alloy, CoZrNb, CoZrTa, an FeTa alloy, and an FeCo alloy. The isolation layer may be formed of a non-magnetic metal or a non-metallic material. The magnetic domain control layer may be formed of IrMn.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other features and aspects of the present invention will become more apparent by describing in detail exemplary embodiments thereof with reference to the attached drawings in which:

FIG. 1 is a cross-sectional view of a perpendicular magnetic recording medium according to an exemplary embodiment of the present invention;

FIGS. 2A and 2B are cross-sectional views illustrating the write and read operations of the perpendicular magnetic recording medium of FIG. 1;

FIG. 3 is a cross-sectional view of a perpendicular magnetic recording medium according to another exemplary embodiment of the present invention;

FIG. 4 is a cross-sectional view of a perpendicular magnetic recording medium according to another exemplary embodiment of the present invention;

FIG. 5 is a cross-sectional view of a soft magnetic underlayer (SUL) structure that can be applied in a perpendicular magnetic recording medium, according to an exemplary embodiment of the present invention;

FIG. 6 is a graph illustrating a relationship between thickness and magnetic characteristics of an SUL formed of CoZrNb of a perpendicular magnetic recording medium;

FIG. 7A is a cross-sectional view of a soft magnetic underlayer structure that can be applied in a perpendicular magnetic recording medium, according to another exemplary embodiment of the present invention;

FIG. 7B is a graph illustrating a relationship between an applied magnetic field and the resulting magnetization of the SUL structure of FIG. 7A;

FIG. 8 illustrates SUL structure samples (a), (b), and (c) for comparing signal-to-noise ratios (SNRs) thereof;

FIGS. 9A through 9C are simulation results respectively illustrating the magnetic domain structures of the samples (a), (b), and (c) of FIG. 8; and

FIGS. 10A through 10C are simulation results respectively illustrating magnetic domain wall noises of the samples (a), (b), and (c) of FIG. 8.

### DETAILED DESCRIPTION OF EXEMPLARY EMBODIMENTS OF THE INVENTION

The present invention will now be described more fully with reference to the accompanying drawings, in which exemplary embodiments of the invention are shown.

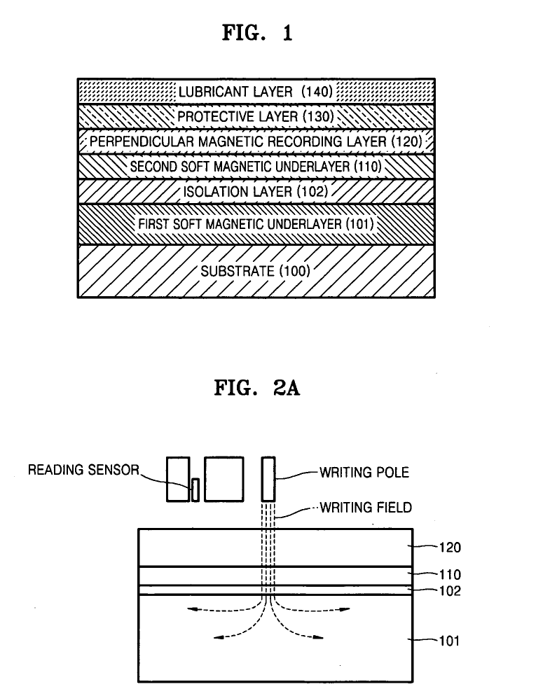

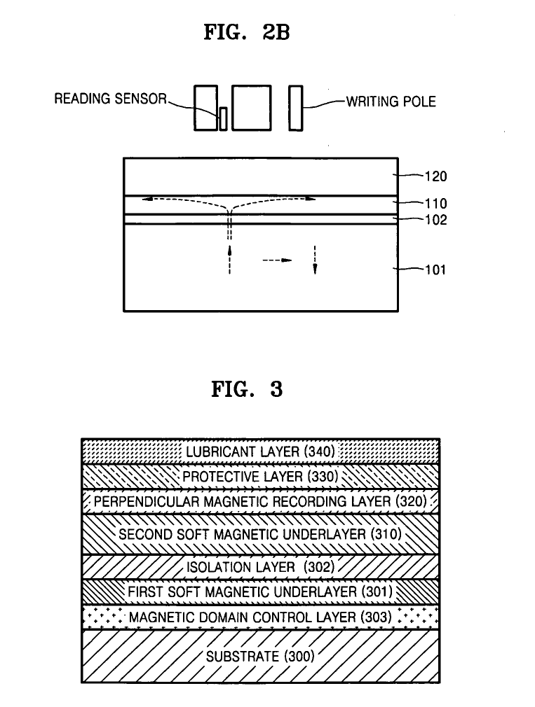

FIG. 1 is a cross-sectional view of a double-layered perpendicular magnetic recording medium including a soft magnetic underlayer (SUL) according to an exemplary embodiment of the present invention, and FIGS. 2A and 2B are cross-sectional views illustrating the write and read operations using the perpendicular magnetic recording medium of FIG. 1.

Referring to FIG. 1, a perpendicular magnetic recording layer 120 is formed over a substrate 100, a protective layer 130 is formed on the perpendicular magnetic recording layer 120 to protect the perpendicular magnetic recording layer 120 from external influences, and a lubricant layer 140 is formed on the protective layer 130 to reduce wear resulting from contact between a magnetic head of a hard disk drive (HDD) and the protective layer 130.

The lubricant layer 140 is formed of tetraol, the protective layer 130 is formed of diamond-like carbon (DLC), the perpendicular magnetic recording layer 120 is formed of one selected from the group consisting of CoCrPtSiO₂, CoPt, CoCrPt, and FePt, and the substrate 100 is formed of glass or Al—Mg.

A first SUL 101 is disposed between the perpendicular magnetic recording layer 120 and the substrate 100 to form a magnetic path of a perpendicular magnetic field and enable information to be recorded on the perpendicular magnetic recording layer 120.

Both a second SUL 110 and an isolation layer 102 that is formed below the second SUL 110 are interposed between the first SUL 101 and the perpendicular magnetic recording layer 120. The isolation layer 102 is formed of a non-magnetic material, such as Ta or Ti, and prevents magnetic interaction between the second SUL 110 and the first SUL 101.

According to the present exemplary embodiment, the anisotropy field Hₖ of the second SUL 110 is greater than that of the first SUL 101, and the magnetic permeability of the second SUL 110 is less than that of the first SUL 101.

Due to the relatively low anisotropy field Hₖ, the first SUL 101 forms a perpendicular magnetic path with a high write field gradient during magnetic recording, thereby making it possible to record information at high density. The second SUL 110 horizontally disperses stray magnetic fields generated by domain walls present in the first SUL 101 during information reproduction, thereby preventing the stray magnetic fields from reaching the read head.

That is, referring to FIG. 2A, the magnetic path of the perpendicular magnetic field output from the head when perpendicular magnetic recording is performed using the magnetic head is formed by the first SUL 101, thereby enabling information to be recorded on the perpendicular magnetic recording layer 120. Referring to FIG. 2B, the second SUL 110 disperses (i.e. shunts) the stray magnetic fields generated by the magnetic domain walls of the first SUL 101 when a magnetic pattern recorded on the perpendicular magnetic recording layer 120 is reproduced, thereby preventing the stray magnetic fields from reaching the magnetic head during the information reproduction and greatly improving a signal-to-noise ratio (SNR) of reproduced information.

Since the second SUL 110 having a stable domain structure due to having the relatively high anisotropy field Hₖ is disposed over the first SUL 101 having the high write field gradient due to having the relatively low anisotropy field Hₖ, the second SUL 110 can shunt stray magnetic fields generated from the first SUL 101 having an unstable domain structure.

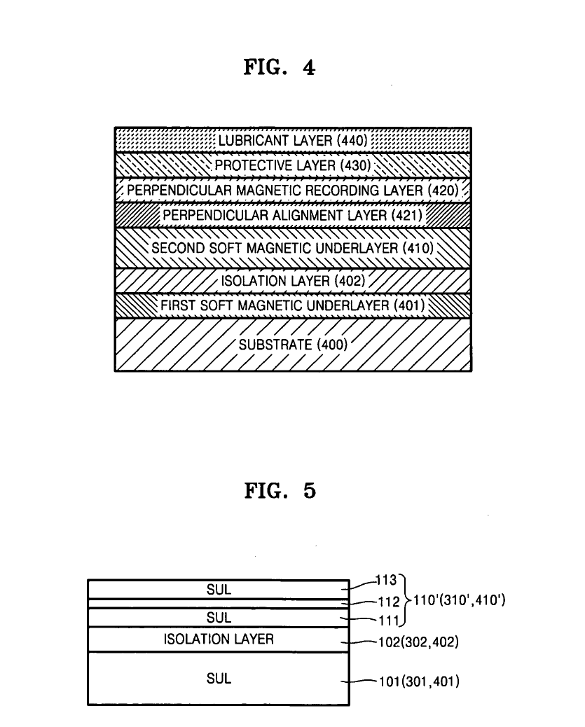

FIG. 3 is a cross-sectional view of a perpendicular magnetic recording medium according to another exemplary embodiment of the present invention. The perpendicular magnetic recording medium of FIG. 3 further includes a magnetic domain control layer 303 in comparison with the perpendicular magnetic recording medium of FIG. 1.

In detail, a perpendicular magnetic recording layer 320 is formed over a substrate 300, a protective layer 330 is formed on the perpendicular magnetic recording layer 320 to protect the perpendicular magnetic recording layer 320, and a lubricant layer 340 is formed on the protective layer 330. The perpendicular magnetic recording layer 320 is formed below the protective layer 330. A second SUL 310, an isolation layer 302, and a first SUL 301 are disposed below the perpendicular magnetic recording layer 320. The magnetic domain control layer 303 is disposed below the first SUL 301 to control the magnetic domains of the first SUL 301. The magnetic domain control layer 303 may be formed of a well-known material such as IrMn, and it is known that the magnetic domain control layer 303 controls the magnetic domains of the first SUL 301 to reduce magnetic domain walls.

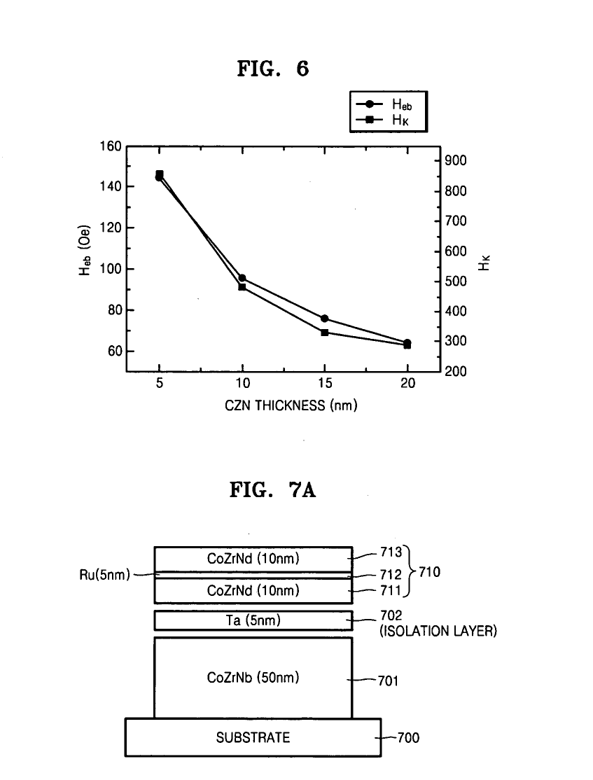

FIG. 4 is a cross-sectional view of a perpendicular magnetic recording medium according to another exemplary embodiment of the present invention. The perpendicular magnetic recording medium of FIG. 4 further includes a perpendicular alignment layer 421 in comparison with the perpendicular magnetic recording medium of FIG. 1.

In detail, a perpendicular magnetic recording layer 420 is formed over a substrate 400, a protective layer 430 is formed on the perpendicular magnetic recording layer 420 to protect the perpendicular magnetic recording layer 420, and a lubricant layer 440 is formed on the protective layer 430. The perpendicular magnetic recording layer 420 and the perpendicular alignment layer 421 are formed below the protective layer 430. A second SUL 410, an isolation layer 402, and a first SUL 401 are disposed below the perpendicular alignment layer 421. The perpendicular alignment layer 421 perpendicularly aligns the magnetic alignment of the perpendicular magnetic recording layer 420.

In addition, a magnetic domain control layer (not shown) for controlling the magnetic domains of the first SUL 401 may be selectively disposed under the first SUL 401 in the same arrangement as shown in FIG. 3.

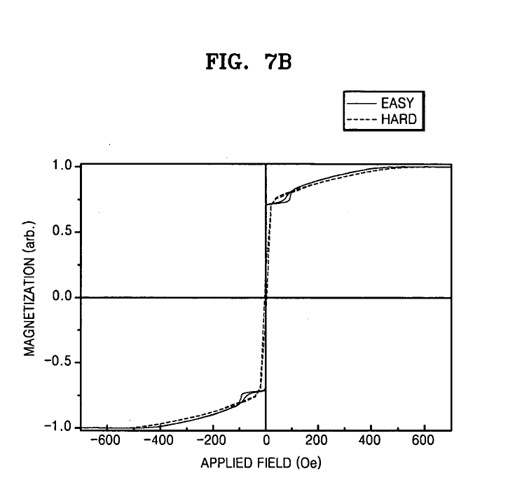

FIG. 5 is a cross-sectional view of a second SUL that can be applied in a perpendicular magnetic recording medium, according to an exemplary embodiment of the present invention. As described above, the isolation layer 102, 302, or 402 for preventing magnetic interaction is formed over the first SUL 101, 301, or 401, and a second SUL 110′, 310′, or 410′ is disposed on the isolation layer 102, 302, or 402. The second SUL 110′, 310′, or 410′ includes upper and lower unit SULs 113 and 111 with a spacer 112 disposed therebetween. The second SUL 110′, 310′, or 410′ forms a (Ruderman-Kittel-Kasuya-Yosida) RKKY coupling such that magnetic domains are locally coupled. Here, the RKKY coupling refers to a coupling mechanism in which upper and lower magnetic layers are antiferromagnetically coupled to each other through a non-magnetic metal layer therebetween. To this end, the thickness of the second SUL 110′, 310′, or 410′ is less than that of the first SUL 101, 301, or 401, and the anisotropy field Hₖ of the second SUL 110′, 310′, or 410′ is greater than that of the first SUL 101, 301, or 401.

The second SUL 110′, 310′, or 410′ is formed of one selected from the group consisting of CoZrNb, CoZrTa, an FeTa alloy, and an FeCo alloy. The first SUL 101, 301, or 401 may be formed of one selected from the group consisting of a NiFe alloy, CoZrNb, CoZrTa, an FeTa alloy, and an FeCo alloy.

The first SUL 101, 301, or 401 and second SUL 110′, 310′, or 410′ may be formed of the same material. The saturation magnetic flux density Bs and the anisotropy field Hₖ of the second SUL 110′, 310′, or 410′ are greater than those of the first SUL 101, 301, or 401, and the magnetic permeability of the second SUL 110′, 310′, or 410′ is less than that of the first SUL 101, 301, or 401. The first SUL 101, 301, or 401 has a thickness of 50 nm or more, and the anisotropy field Hₖ of the second SUL 110′, 310′, or 410′ can be controlled by adjusting the thickness of each of the upper and lower unit SULs 113 and 111. Each of the upper and lower unit SULs 113 and 111 are formed to have a thickness in the range of 1 to 5 nm, and the spacer 112 between the upper and lower unit SULs 113 and 111 is formed of a non-magnetic material, such as Ru, and has a thickness of 2 nm or less. The isolation layer 102, 302, or 402 is formed of a non-magnetic metal or oxide.

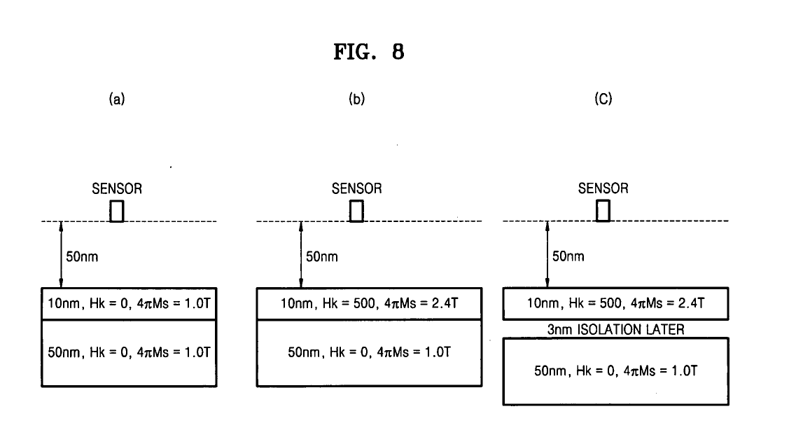

FIG. 6 is a graph illustrating a relationship between thickness, coupling strength H_{eb}, and anisotropy field Hₖ of a second SUL formed of CoZrNb and having an RKKY coupling structure.

Referring to FIG. 6, as the coupling strength H_{eb} representing an antiferromagnetic exchange coupling between upper and lower unit SULs increases, the anisotropy field Hₖ increases proportionally. The anisotropy field Hₖ should be high to prevent the formation of magnetic domain walls that act as noise sources. Referring to FIG. 6, each of the upper and lower unit SULs may be formed to have thicknesses less than 5 nm to obtain a high anisotropy field Hₖ.

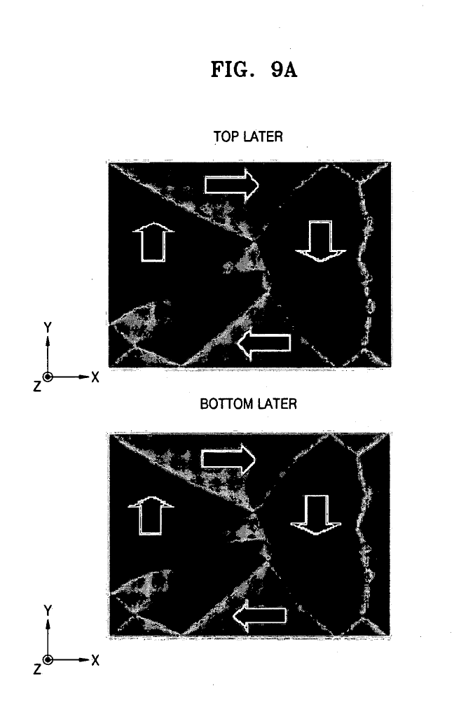

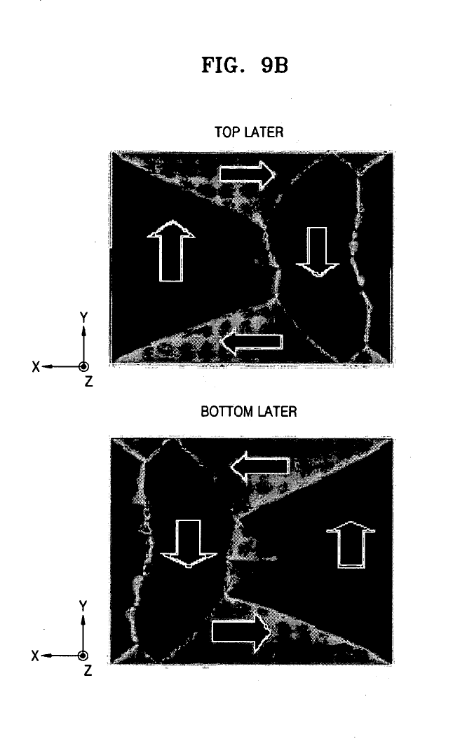

FIG. 7A is a cross-sectional view of an SUL structure that can be applied in a perpendicular magnetic recording medium, according to another exemplary embodiment of the present invention.

Referring to FIG. 7A, a first SUL 701 formed of CoZrNb is formed to have a thickness of 50 nm on a substrate 700, and has a low anisotropy field Hₖ that may be zero (0). An isolation layer 702 formed of Ta is formed to have a thickness of 5 nm on the first SUL 701. A second SUL 710 having an RKKY coupling structure and a high anisotropy field Hₖ is formed on the isolation layer 702. The second SUL 710 includes two upper and lower unit SULs 713 and 711, and a spacer 712 is formed of Ru and has a thickness of 5 nm between the upper and lower unit SULs 713 and 711.

FIG. 7B is a graph illustrating a relationship between an applied magnetic field and a resulting magnetization of the SUL structure of FIG. 7A.

Referring to FIG. 7B, exchange interactions between the first SUL 701 and the second SUL 710 can be completely prevented and the anisotropy field Hₖ of the second SUL 710 can be greater than approximately 500 Oe.

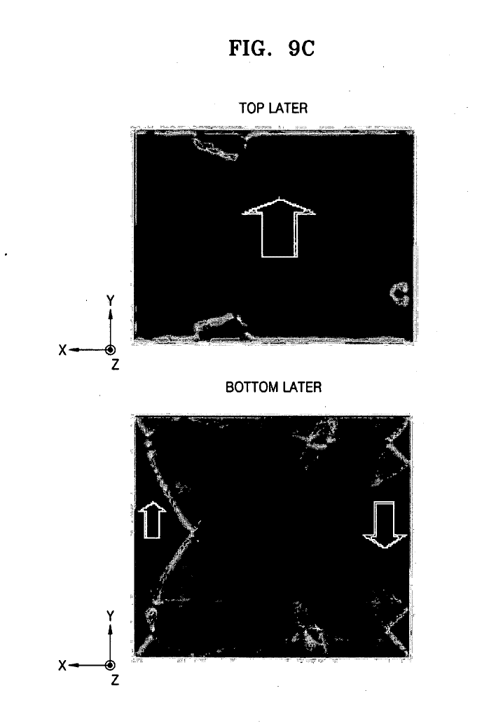

FIG. 8 illustrates SUL structure samples (a), (b), and (c) for comparing SNRs thereof. The first sample (a) is a related art single-layered SUL structure, the second sample (b) is a related art antiferromagnetic SUL structure in which top and bottom layers contact each other, and the third sample (c) is an SUL structure according to exemplary embodiments of the present invention in which top and bottom layers are disposed with an isolation layer therebetween.

Each of the samples (a), (b), and (c) has a top layer having a thickness of 10 nm and a bottom layer having a thickness of 50 nm, and all the bottom layers have an anisotropy field Hₖ of zero (0) and a saturation magnetization 4πMs of 1.0 T. The top layer of the first sample (a) has an anisotropy field Hₖ of zero (0) and a saturation magnetization 4πMs of 1.0 T, and the top layers of the second and third samples (b) and (c) each have an anisotropy field Hₖ of 500 and a saturation magnetization 4πMs of 2.4 T. The third sample (c) has an isolation layer having a thickness of 3 nm.

Simulation was performed assuming that a sensor for detecting magnetic fields is positioned at a distance of approximately 50 nm from each of the top layers.

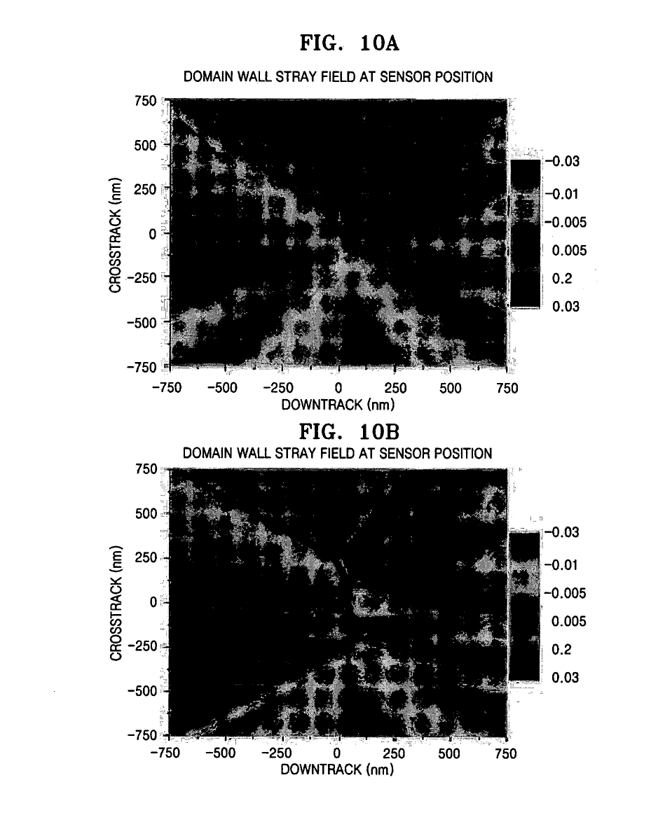

FIGS. 9A, 9B, and 9C are simulation results respectively illustrating the magnetic domain structures of the samples (a), (b), and (c) of FIG. 8.

Referring to FIGS. 9A, 9B, and 9C, the third sample (c), shown in FIG. 9C, has a better magnetic domain structure than the other samples (a) and (b).

A plurality of magnetic domain walls acting as magnetic noise sources are shown in FIGS. 9A and 9B which respectively illustrate the first and second samples (a) and (b), while magnetic domain walls are rarely shown in the third sample (c), shown in FIG. 9C, due to the strong anisotropy field of the top layer nearest the sensor of the third sample (c). It can be seen that the SUL structure of the third sample (c) is suitable to provide a high SNR.

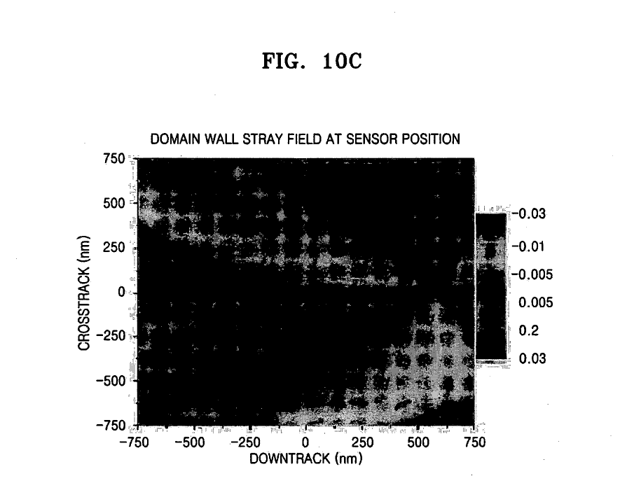

FIGS. 10A, 10B, and 10C are simulation results respectively illustrating magnetic domain wall noises of the samples (a), (b), and (c) of FIG. 8 detected by the sensor. The third sample (c) according to an exemplary embodiment of the present invention, shown in FIG. 10C, greatly suppresses noise compared to the samples (a) and (b) shown in FIGS. 10A and 10B, respectively.

Referring to FIG. 10A, stray magnetic fields detected by the sensor have magnetic field strengths greater than 300 Oe. Referring to FIG. 10B illustrating the simulation result of the sample (b) having no isolation layer between the top and bottom SULs, large stray magnetic fields are formed due to perpendicular magnetic domains. On the other hand, referring to FIG. 10C illustrating the simulation result of the third sample (c) according to an exemplary embodiment of the present invention, the strengths of stray magnetic fields are drastically reduced to 100 Oe or less, thereby effectively reducing noise.

Various types of SUL structures for perpendicular magnetic recording media have been explained in the above exemplary embodiments. According to exemplary embodiments of the present invention, the second SUL having a relatively high anisotropy field disperses (shunts) stray magnetic fields (noise) generated by the magnetic domain walls of the first SUL having a relatively low anisotropy field. Accordingly, various other exemplary embodiments can be implemented without departing from the scope of the present invention.

In particular, the above exemplary embodiments have shown a basic structure of a perpendicular magnetic recording medium, and thus auxiliary or additional layers may be further stacked. For example, an additional SUL may be formed within the spirit and scope of the present invention, and is not intended to limit the technical scope of the present invention. Also, the materials used to form the constituent elements of the perpendicular magnetic recording medium according to exemplary embodiments of the present invention are well known and do not limit the technical scope of the present invention.

As described above, according to exemplary embodiments of the present invention, noise resulting from an SUL that is inevitably used in a perpendicular magnetic recording medium can be remarkably reduced and thus an SNR and recording density thereof can be increased. That is, since a high write field gradient can be formed by the first SUL having a high magnetic permeability during a write operation, high density recording can be achieved. Furthermore, since the second SUL having a low thickness and a high anisotropy field disperses stray magnetic fields generated by the first SUL, noise caused by the magnetic domain walls of the first SUL can be greatly reduced.

The present invention is suitable for application in any type of perpendicular magnetic recording media employing SULs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising:
a substrate;
a perpendicular magnetic recording layer which is formed over the substrate;
a first soft magnetic underlayer which is disposed between the perpendicular magnetic recording layer and the substrate;
a second soft magnetic underlayer which is disposed between the first soft magnetic underlayer and the perpendicular magnetic recording layer; and
an isolation layer which is disposed between the first soft magnetic underlayer and the second magnetic layer, and which prevents magnetic interaction between the first soft magnetic underlayer and the second soft magnetic underlayer,
wherein anisotropy field Hₖ of the second soft magnetic underlayer is greater than anisotropy field Hₖ of the first soft magnetic underlayer.

2. The perpendicular magnetic recording medium of claim 1, wherein the second soft magnetic underlayer forms a Ruderman-Kittel-Kasuya-Yosida (RKKY) coupling and includes at least one stacked structure in which a pair of unit soft magnetic underlayers is stacked which has a non-magnetic spacer formed therebetween.

3. The perpendicular magnetic recording medium of claim 1, wherein the second soft magnetic underlayer is thinner than the first soft magnetic underlayer.

4. The perpendicular magnetic recording medium of claim 3, wherein the second soft magnetic underlayer has a thickness of between 1 and 12 nm, and the first soft magnetic underlayer has a thickness of 50 nm or more.

5. The perpendicular magnetic recording medium of claim 3, wherein the first soft magnetic underlayer and the second magnetic layer are formed of the same material.

6. The perpendicular magnetic recording medium of claim 2, wherein the second soft magnetic underlayer includes two unit soft magnetic underlayers and one spacer formed between the two unit soft magnetic underlayers,
wherein each of the unit soft magnetic underlayers has a thickness of between 1 and 5 nm, the spacer has a thickness of 2 nm or less, and the first soft magnetic underlayer has a thickness of 50 nm or more.

7. The perpendicular magnetic recording medium of claim 3, wherein the second soft magnetic underlayer is formed of one selected from CoZrNb, CoZrTa, an FeTa alloy, and an FeCo alloy.

8. The perpendicular magnetic recording medium of claim 7, wherein the first soft magnetic underlayer is formed of one selected from a NiFe alloy, CoZrNb, CoZrTa, an FeTa alloy, and an FeCo alloy.

9. The perpendicular magnetic recording medium of claim 2, wherein the isolation layer is formed of a non-magnetic metal or a non-metallic material.

10. The perpendicular magnetic recording medium of claim 2, further comprising a magnetic domain control layer which is disposed between the first soft magnetic underlayer and the substrate.

11. The perpendicular magnetic recording medium of claim 10, wherein the second soft magnetic underlayer is thinner than the first soft magnetic underlayer.

12. The perpendicular magnetic recording medium of claim 11, wherein the second soft magnetic underlayer has a thickness of 1 to 12 nm, and the first soft magnetic underlayer has a thickness of 50 nm or more.

13. The perpendicular magnetic recording medium of claim 12, wherein the first soft magnetic underlayer and the second soft magnetic underlayer are formed of the same material.

14. The perpendicular magnetic recording medium of claim 12, wherein the second soft magnetic underlayer is formed of one selected from CoZrNb, CoZrTa, an FeTa alloy, and an FeCo alloy.

15. The perpendicular magnetic recording medium of claim 10, wherein the isolation layer is formed of a non-magnetic metal or a non-metallic material.

16. The perpendicular magnetic recording medium of claim 10, wherein the magnetic domain control layer is formed of IrMn.
